(19) United States
(12) Patent Application Publication
(10) Pub. No.: US 2005/0020273 A1
(43) Pub. Date: Jan. 27, 2005

(54) Adaptive dual-mode reverse link scheduling method for wireless telecommunications networks

(75) Inventors: Mo-Han Fong, L'Orignal (CA); Derek Yu, Kanata (CA); Jun Li, Richardson, TX (US); Ashvin Chheda, Plano, TX (US); Wen Tong, Ottawa (CA); Geng Wu, Plano, TX (US)

Correspondence Address: CARR LAW FIRM, L.L.P., 670 FOUNDERS SQUARE, 900 JACKSON STREET, DALLAS, TX, 75202, US

(73) Assignee: Nortel Networks Limited, St. Laurent (CA)

(21) Appl. No.: 10/626,056

(22) Filed: Jul. 24, 2003

(51) Int. Cl. H04Q 7/20

(52) U.S. Cl. 455/453; 455/442; 455/67.11

(57) ABSTRACT

The present invention provides for a scheduling scheme to be used with respect to a given mobile station. It is determined whether the given mobile station is or is not in soft-handoff. This is performed through examining a reduced active set. The reduced active set is based upon the active set, and the selection of the reduced active set includes considerations such as received reverse link channel signal strength. If the mobile station is in soft hand-off or with reduced active set size of greater than one, congestion control scheduling of reverse link communications from the given mobile station is utilized, using a data rate set by the congestion control of the reverse link channel. If the mobile station is not in soft-handoff or with reduced active set size of one, explicit scheduling of the reverse link communications from the given mobile station is utilized, using a data rate set by the explicit data rate control of the reverse link channel.

### CROSS-REFERENCED APPLICATION

This application relates and claims priority from co-pending U.S. provisional patent application 15541ROUS01P, filed Jul. 31, 2002, entitled “Adaptive Dual-Mode Reverse Link Scheduling Method for Wireless Telecommunications Networks,” the contents of which are incorporated by reference.

### FIELD OF THE INVENTION

The present invention is generally directed to the management of radio resources in terms of traffic channel data rates of reverse links and, more particularly, to selecting between reverse link channel data rate assignment in an explicit mode and a reverse link channel data rate assignment in a congestion control mode.

### BACKGROUND

Mobile stations (MSs) are an increasingly ubiquitous component of telecommunications infrastructure. MSs can be mobile telephones, laptop computers with a radio link, or other portable devices adapted to receive wireless data from a transmitter to the MS over a forward link channel.

Furthermore, an MS can also have a reverse link, which contains a reverse link channel. Generally, a reverse link channel is used to convey information from a mobile station (MS) to a base transceiver station (BTS). Reverse link channels have characteristics, such as the allowable data rates which corresponds to the modulation and coding scheme, for transmission on the given reverse link channel, that are calculated by a base station. The base station configures the MS reverse link channel characteristics over the forward link, and receives data at the specified data rate from the MS over the reverse link channel.

In code division multiple access (CDMA) protocols, each reverse link is identified by the BTS through use of the unique radio configuration assigned to the reverse link. One unique reverse link traffic channel is assigned to each MS by the BS. There are two basic modes of signaling the reverse link channel data rates to the MS, thereby informing the MS of the assigned data rates of the reverse link channel. The first mode is an “explicit data rate assignment” (EDRA). The second mode is through “congestion control (CC).”

In EDRA, the base station informs the MS at exactly what data rate to transmit information to the BTS over the reverse link channel of the MS, and for what specified amount of time. Alternatively, the MS can be implicitly told not to transmit at all, through not receiving authorization to transmit from a certain time to a certain time at any data rate. The EDRA rate can be calculated either at the BSC (slow scheduling) or at each BTS (fast scheduling) of the base station. Fast scheduling avoids latency in transmission for the various decisions and calculations of reverse link channel configured parameters from the BSC to the BTS.

The EDRA configuration information is sent over a reverse shared channel assignment channel (RSCACH) to the MS over the forward link channel. As the name suggests, each MS listens for its own identifier over a common forward link channel, the RSCACH. If the MS recognizes its own identifier, the MS sets its reverse link channel data rate at the explicit rate extracted from the RSCACH. The MSs monitors the RSCACH for their own radio configuration, and only one assignment can be given at a time on a RSCACH.

In CC, each MS is commanded to step to either the next higher or lower predefined data rate of reverse link channel transmission, or to keep the rate of transmission over the reverse link channel at a constant rate. However, unlike EDRA, each MS has its own unique forward link CDMA channel to receive these commands. This channel is a reverse dedicated congestion control channel {or subchannel} (RDCCCH), and these commands are received periodically by the MS. The starting data bit rate for CC is known to both the MS and the BS. The CC rate can be calculated at the BSC (slow scheduling) or at each BTS (fast scheduling). Alternatively, there can be a situation wherein each BTS sends out a single up/down command on the RDCCCH, and all MSs within the broadcast area that are listening to that channel have their respective reverse link channel data rates increased or decreased in a specified level. As is readily apparent, the CC approach does not have the fine control for setting the reverse link transmission data rate that EDRA has.

One problem with the reverse link signaling of data rates occurs in the “soft-handoff” mode when also using the “fast scheduling” EDRA assignment. As is understood by those of skill in the art, generally a soft-handoff occurs when an MS is in communication with two or more BTSs at the same time. Soft-handoff can be due to the MS going from one BTS section to another BTS region, the need for signal path diversity, and so forth.

In soft-handoff, if the MS is receiving two different data rate command signals from the separate BTSs in the CC mode, the MS will transmit at the lower rate designated by the two BTSs. This data rate differential can happen in distributed per-BTS scheduling, as each BTS calculates the CC rate separately, unlike a centralized scheduling system from a BSC. Similarly, if the MS is receiving two different signals from two different BTSs in the EDRA mode, the MS will transmit at the lower rate. Again, this can happen in distributed per-BTS scheduling. In the CC mode, neither BTS will tell the MS, either explicitly or implicitly, to stop transmitting on the reverse link channel. In the EDRA mode, however, one BTS can tell the MS to transmit at an explicit data rate on the reverse link channel, and the other BTS can withhold authorization for the MS to transmit at all.

This situation puts the MS in a quandary. If the MS chooses to transmit over its reverse link channel, when it's permission to transmit was withheld by one of the two BTSs, this can create unacceptable interference to the BTS that directed the MS not to transmit. On the other hand, if the MS does not transmit at all, the MS is not transmitting to the BTS which could accept a reverse link channel data stream. This means that a soft-handoff situation can have less throughput than a non-soft-handoff situation. However, relying on CC for all transmission control does not give the base station all of the fine control of reverse link channel data rates of EDRA.

Therefore, there is a need for a reverse link scheduling scheme that solves at least some of the problems associated with conventional reverse link scheduling schemes.

### SUMMARY OF THE INVENTION

The present invention selects a scheduling scheme to be used with respect to a given mobile station. It is determined whether the given mobile station is not in soft-handoff. If the mobile station is in soft hand-off, congestion control scheduling of reverse link communications from the given mobile station is utilized. If the mobile station is not in soft-handoff, explicit scheduling of the reverse link communications from the given mobile station is utilized. Dynamically switching from the explicit scheduling mode to the congestion control mode achieves the benefits of both modes and overcomes at least some of the disadvantages of each mode.

### BRIEF DESCRIPTION OF THE DRAWINGS

For a more complete understanding of the present invention, and the advantages thereof, reference is now made to the following description taken in conjunction with the accompanying drawings, in which:

FIG. 1A illustrates a prior-art distributed explicit signaling system for setting a reverse link channel data rate for at least one MS;

FIG. 1B illustrates a prior-art distributed congestion control signaling system setting a reverse link channel data rate for at least one MS;

FIG. 2 illustrates a distributed combined explicit and congestion control signaling system for setting a reverse link channel data rate for at least one MS; and

FIG. 3 illustrates a method of setting a data rate for a reverse link channel of an MS as a function of whether the MS is in soft-handoff mode.

### DETAILED DESCRIPTION

In the following discussion, numerous specific details are set forth to provide a thorough understanding of the present invention. However, it will be understood by those skilled in the art that the present invention can be practiced by those skilled in the art following review of this description, without such specific details. In other instances, well-known elements have been illustrated in schematic or block diagram form in order not to obscure the present invention in unnecessary detail. Additionally, for the most part, details concerning CDMA systems and the like have been omitted inasmuch as such details are not considered necessary to obtain a complete understanding of the present invention, and are considered to be within the skills of persons of ordinary skill in the relevant art.

It is further noted that, unless indicated otherwise, all functions described herein are performed by a processor such as a computer or electronic data processor in accordance with code such as computer program code, software, and/or integrated circuits that are coded to perform such functions.

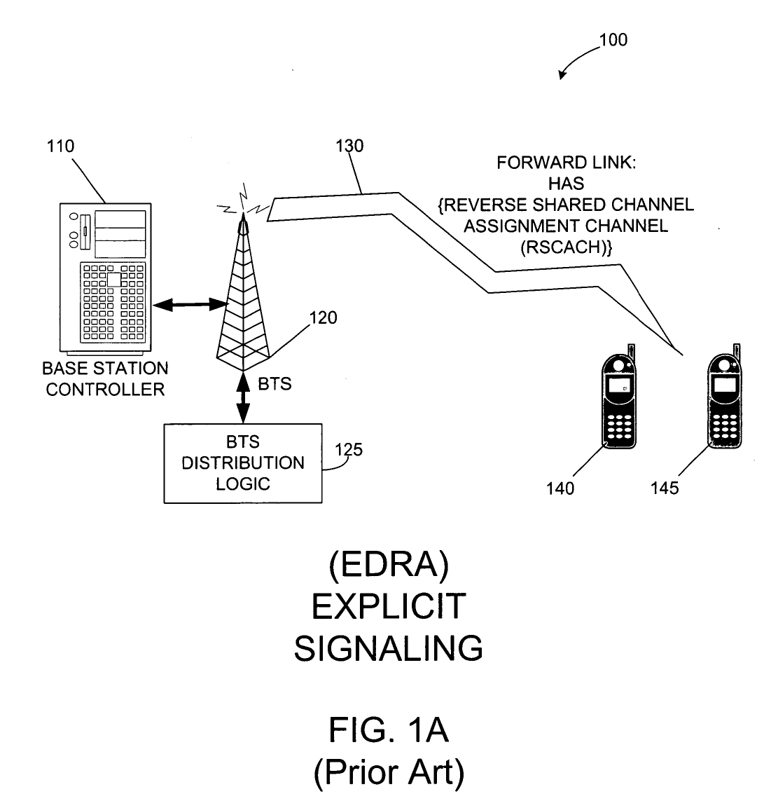

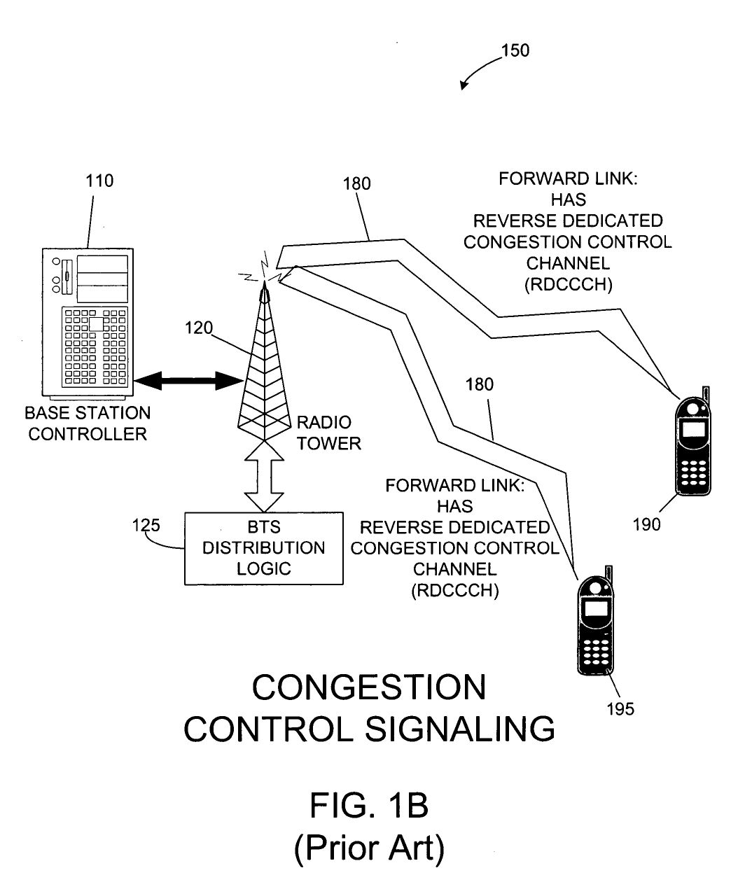

Turning now to FIG. 1A, a system 100 for configuring a reverse link of an MS through explicit signaling is illustrated. The system 100 has a base station controller (BSC) 110 coupled to a BTS 120. The BTS 120 has BTS distribution logic 125. The BTS 120 communicates with the MSs 140, 145 over the RSCACH 130 of a forward link. The BSC 110, the BTS 120 and the BTS distribution logic 125 comprise a base station.

Generally, in FIG. 1A, EDRA reverse link channel data rate signaling occurs between the BTS 120 and the MSs 140, 145. The mobiles 140, 145 estimate the reverse link channel condition by measuring the reverse link pilot channel transmission power required to ensure an acceptable received signal-to-noise ratio at the BTS 120. These measurements of the pilot channel transmission power are transmitted to the BTS 120 over a channel of the reverse link (not shown). The BTS distribution logic 125 calculates the explicit selected reverse link channel data rate for each reverse link of each MS 140, 145. Employment of the BTS distribution logic 125, instead of the BSC 110, to calculate the reverse link channel data rate for the MS 140, 145 allows for a faster reaction to changes in reverse link channel conditions.

The BTS 120 transmits the selected reverse link channel data rate to the MSs 140, 145 over the RSCACH of the forward link 130. Each reverse link channel data rate has a start time and a stop time, and each mobile 140, 145 monitors for its own identifier within the RSCACH. If the MS 140, 145 detects its own identifier, the MS 140, 145 then explicitly sets its own reverse link channel to the explicit data rate determined by the BTS distribution logic 125. If the MS 145 does not detect its own identifier within the RSCACH, the MS is denied permission to transmit over the reverse link channel until receiving permission from the BTS distribution logic 125 to transmit at a given data rate.

Turning now to FIG. 1B, a system 150 for setting a data rate of a reverse link channel of an MS through congestion control signaling is illustrated. The system 150 has the BSC 110 coupled to the BTS 120. The BTS 120 has BTS distribution logic 125. The BTS 120 communicates with the MSs 190,195 over their own respective RDCCCHs of a forward link 180.

Generally, in FIG. 1B, congestion control (CC) signaling occurs between the BTS 120 and the MSs 190, 195. The MSs 190, 195 estimate the reverse link channel condition by measuring the reverse link pilot channel transmission power required to ensure an acceptable received signal-to-noise ratio at the BTS 120. These measurements are transmitted to the BTS 120 over a channel of the reverse link (not shown). The BTS distribution logic 125 calculates whether the MSs 190, 195 are to increase their reverse link channel data rate by a predetermined step, decrease their reverse link channel data rate by a predetermined step, or to have the MSs 190, 195 maintain a constant data rate of their respective reverse link channels.

The BTS 120 transmits the congestion control command to set the reverse link channel data rate at the next step. In other words, the BTS 120 commands the reverse link channel data rate to be increased to the next predefined rate, down to the next predefined rate, or alternatively the predefined rate stays at the same level. This transmission is received and decoded by the MSs 190,195 over the RDCCCHs of the forward link 130. Each mobile 190,195 has its own RDCCCH, although mobiles can also share the same RDCCCH. The MSs 190, 195 set their reverse link channel data rate as a function of the commands sent by the BTS distribution logic 125.

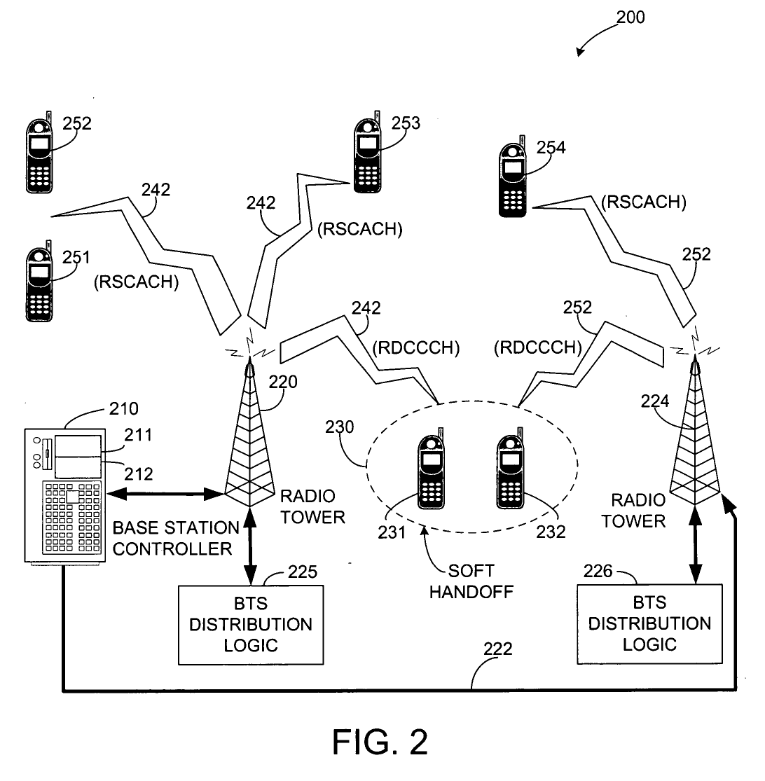

Turning now to FIG. 2, illustrated is a system 200 of a dynamic distributed combined explicit and congestion control reverse link channel data rate assignment system. Generally, the system 200 performs EDRA scheduling when an MS is not in a soft-handoff mode, and CC scheduling when the MS is in a soft-handoff mode. This has the advantage of using explicit reverse link channel data rate control, for at least the part of the time for the MS when the MS is not in soft-handoff, thereby giving the BTS more precise control over the reverse link channel data rate. However, when the MS is in soft-handoff, the BTSs switch (if they are not there already) to CC control, thereby avoiding the situation of both BTSs issuing their own respective contradictory “transmit/do not transmit” transmission commands to the MS.

The system 200 has a BSC 210 coupled to a BTS 220. The BTS 220 has BTS distribution logic 225. The BSC 210, the BTS 220, and the BTS distribution logic 225 comprise a base station. The BTS 220 communicates with the MSs 251, 252 and 253 over the RSCACH of a forward link 242. The BTS 220 further communicates with the mobiles 231 and 232 in the soft-handoff zone 230 over the RDCCCH of the forward link 242.

The BSC 210 is further coupled through a transmission line 222 to a BTS 224. The BTS 224 has BTS distribution logic 226. The BTS 224 communicates with the MS 254 over the RSCACH of a forward link 252. The BTS 224 further communicates with the mobiles 231 and 232 in the soft-handoff zone 230 over the RDCCCH of the forward link 252. The BSC 210 and the BTS 220, the BTS distribution logic 225, transmission line 222, BTS 224 and BTS distribution logic 226 comprise a base station.

When entering a soft-handoff mode initiated by the BSC 210, the MS listens to the RDCCCHs transmitted by BTSs that correspond to the list provided by the BSC. Mode switching (that is, switching from EDRA mode to CC mode to set a reverse link channel data rate) can be triggered by a change in an “active” set. The active set is generated by the BSC 210 and sent to the MSs and is used in conjunction with reverse link channel data rate control. In the system 200, the BSC 210 comprises an active set generator 211.

In CDMA, the “active set” is generally defined as those BTSs which are in communication with a given MS for use either for single BTS data transfer or for use in soft-handoff. The active set of BTSs is determined by the BSC 210, based upon the forward link pilot strength of various BTSs, such as the BTSs 220, 224 as measured by the given MS. Typically, this active set is a function of the pilot channel strength when compared to absolute or relative power thresholds.

An “active set update procedure” is a procedure by which a given MS is updated as to which BTS to receive from on the forward link and transmit to on the reverse link, as determined by the BSC 210. Typically, each MS receives its active set update through air interface layer 3 signaling. If the active set is greater than one, then the MS is assigned an RDCCCH channel for each of the BTSs with which the MS is to be in soft-handoff. Also, in RDCCCH mode, the initial data rate, from which predefined incremental change in the data rate is calculated, is sent from the BSC to the MS in air interface layer 3 signaling format.

For instance, in the system 200, the mobiles 251,252, 253 are in communication with one BTS, the BTS 220. Therefore, explicit reverse link channel data rates are sent to those MSs from the BTS 220 over the RSCACH within the forward link 242. Similarly, the mobile 254 is in communication with one BTS, the BTS 224, over the forward link 252. Therefore, again, explicit reverse link channel data rates are sent to those MSs from the BTS 220 over the RSCACH. However, the MS 231 and 232 are in the soft-handoff area 230 serviced by both the BTS 220 and 224 over the two forward links 242, 252. Therefore, the MS 231, 232 have their reverse link data channel rate information sent over an RDCCCH from both the BTS 220, 224. If there is a conflict, the MSs 231, 232 transmit at the lower rate. In one embodiment, the steps of congestion control comprise a command to double or halve the data rate sent from the MS. Generally, use of the system 200 allows for employment of both explicit data signaling control and congestion control within the same mobile system, without the drawbacks of explicit control signaling in regions of soft-handoff.

In a further aspect of the system 200, there is defined a “reduced active set.” Within the reduced active set, the BTSs of the active set measure characteristics the reverse link channel transmitted by a given MS, such as signal strength, interference, background noise, and so on of the reverse link channel. These measurements are forwarded to the BSC 210, which determines which ofthe members of the “active set” would be the best to send the data rate assignment information to the MS, thereby defining the “reduced active set.” Typically, the best BTS to send the data rate assignment to mobile station can be based upon such considerations as the channel conditions of the reverse link as measured at the BTS. The BSC 210 further comprises a reduced active set generator 212.

In FIG. 2, the reduced active set is used to perform the congestion control (CC) signaling from the BTS 220 to the MS if the number of members of the reduced active set is greater than one. If the number of the members is equal to one, that member BTS signals reverse link channel data rate information through the EDRA link. In the system 200, the MS can read the EDRA over the forward link from the BTS specified within the reduced active set, if the reduced active set has only one member, through the MS the being told explicitly to read the EDRA over the forward link of the reduced active set. In FIG. 2, typically each MS is informed of the active set as well as the reduced active set.

In the system 200, if the reduced active consists of only one member BTS, the MS will read the RSCACH transmitted from the BTS corresponding to the entry in the reduced active set. If the MS is informed that it has two or more members of the reduced active set, the MS can determine those BTSs that are members of the reduced active set by being explicitly told through layer 3 signaling. Alternatively, the MS can monitor the signal energy on each RDCCCH of the active set. The RDCCCH channels with signal energy higher than a predefined threshold correspond to those BTSs which should be used by MS to receive the data rate commands, and correspond to the reduced active set.

In a further embodiment, however, there can be a number of reasons for an MS to be told to go into CC mode other than in a soft-handoff situation. These reasons can include the fact that the MS reverse channel link subscription supports congestion control, but does not support EDRA. The reasons can further include that the priority level that is assigned to the MS does not support EDRA. Another reason for employment of CC outside of the soft-handoff region is the type of quality of service (QoS) required for an application running on the MS. For instance, Voice Over IP (VoIP) typically requires relatively constant reverse link channel data rates and, therefore, CC is preferable. However, use of EDRA for sending IP packets using transmission control protocol (TCP) could be beneficial. Other factors affecting the decision of whether to select EDRA or CC data rate control for the reverse link can include the overall reverse link channel condition, or the location of the MS within the cell.

In another embodiment of the system 200, a plurality of RSCACHs are used for explicit signaling control from the BTS, such as the BTS 220. Each MS 251, 252 and 253 can monitor a selected RSCACH of the forward link 242 or, alternatively, all of the RSCACHs within the forward link 242, and the MS 251, 252 and 253 listens for the explicit reverse link channel data rate information.

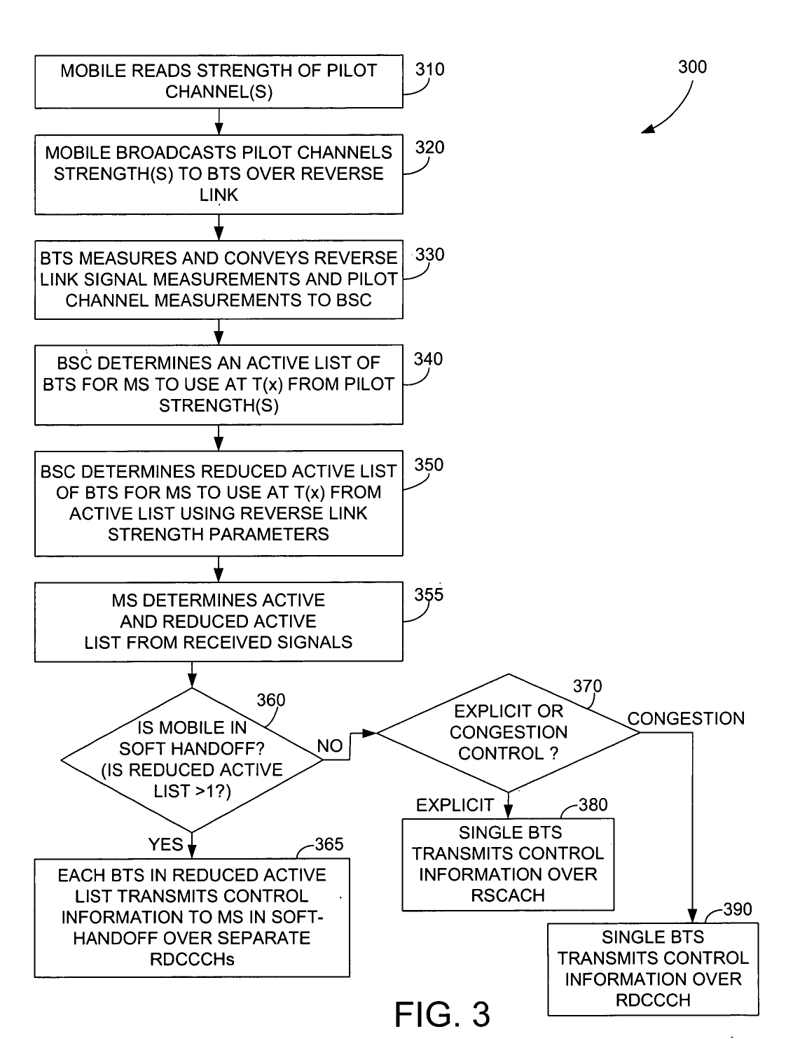

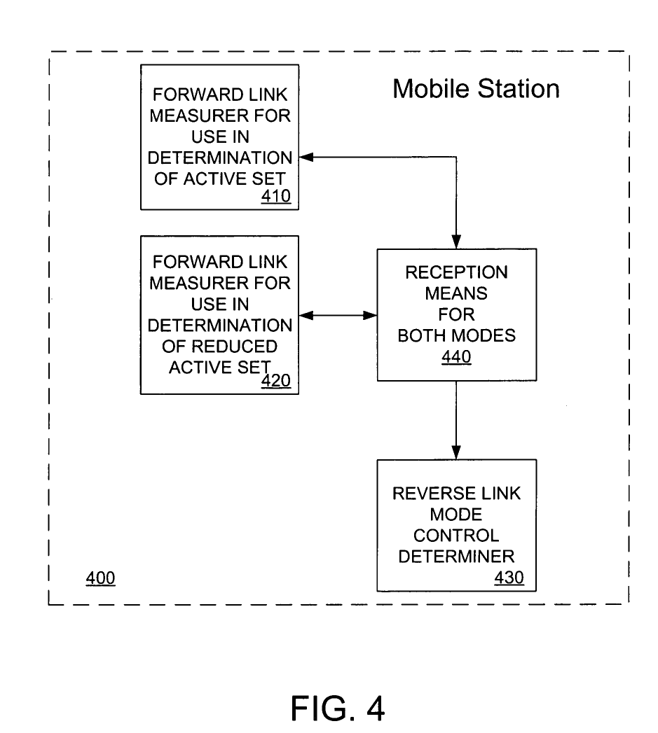

Turning now to FIG. 3, illustrated is a method of configuring an MS using either the explicit or congestion control reverse link data rate assignment as a function of whether the MS is or is not in a soft-handoff mode. In step 310, an MS reads the signal energy of at least one forward link pilot channel. Typically, the MS reads the pilot channel strengths of all of the forward links it can detect. In step 320, the MS transmits the pilot channel strengths over its dedicated reverse link control channel to all BTSs in its active set. In step 330, each BTS measures the strength of the reverse link channel as received from the MS. The signal energy measurements of the reverse link channel are sent to the BSC, as well as the pilot channel strengths of the forward link or links as measured by the MS.

In step 340, the BSC determines the active set of BTS to use for a given time segment as a function of the measured pilot strengths of the BTSs as performed by the MS. In step 350, the BSC determines the reduced active set of BTS for the BTS to use for a given time segment. This is done through selecting a subset of the active set through the use of other parameters, such as reverse link channel strength measured by each BTS of the active set of the reverse link transmitted by the MS.

In step 355, the MS determines the active set and reduced active set from received air interface layer 3 signaling sent through the forward link dedicated control channel assigned to the MS during call setup. This determination of the active set and the reduced active set and the associated RSCACH or RDCCH to be used can occur by monitoring the forward link dedicated control channel. Alternatively, the MS can determine the RDCCCH channels to be used for itself by monitoring the signal strengths of the various RDCCCH channels of the active set. Those RDCCCH channels that have a signal energy above a certain threshold correspond to BTSs within the reduced active set.

In step 360, it is determined whether the MS is in soft-handoff mode. In other words, it is determined whether members of the reduced active set of the MS are greater than one. If the MS is in soft hand-off, each BTS in the reduced active list transmits reverse link channel data rate control information over their separate RDCCCHs in step 365.

However, if the MS is not in soft-handoff, in step 370, a determination is then made as to whether the MS is commanded by the BSC to be in explicit control mode, as received over the RSCACH, or congestion control mode, as received over the RDCCCH. If the MS is to receive its required reverse link channel data rate in the explicit mode, in step 380, the single BTS transmits explicit control information over the RSCACH. If the MS is to receive its required reverse link channel data rate in the congestion mode, in step 390, the single BTS transmits congestion control information over the RDCCCH. Generally, the method 300 uses an adaptive scheme to dynamically switch from the explicit scheduling mode to the congestion control mode.

Turning now to FIG. 4, disclosed is a MS 400 configured to generate information employable by the system 200 to select either the congestion control mode or the fast scheduling EDRA assignment. A reception means 440 receives and reads the forward link or links of one or more BTSs. Then the forward link measurer 410 measures attributes of the forward link or forward links as received by the reception means 440 relevant to determining the active set. Then, the active set attributes are sent to the reception means 440 to be transmitted back to the base station controller.

The forward link measurer 420 measures attributes of the forward link or links as received by the reception means 440 relevant to determining the reduced active set. Then, the reduced active set attributes are sent to the reception means 440 to be transmitted back to the base station controller.

A reverse link mode control determiner 430 measures input of indicia of which reverse link mode control to use as received from the reception means 440. The reception means 440 received instructions, are explicit or implicit, from the base station controller as to what reverse link scheduling mode to use. This determination can be from either being explicitly informed over the forward link as parsed by the reception means 440, or through the measurement of CC energy signals at the reception means 440.

For example, if the numbers of reduced active sets received by the reverse link mode control determiner 430 is greater than one, then congestion control is selected by the reverse link mode control determiner 430. If the count of reduced active sets equal to one, either explicit control or congestion control is used, depending upon the configuration of the reverse link mode control determiner 430.

In the MS 400, the reception means can receive a plurality of explicit data rate mode channels, and can select one of a plurality of the received explicit data rate channels. The reception means can be configured to extract a reverse link data rate from the explicit control data rate channel, or from the congestion control data rate channel. In the MS 400, the reception means can be further configured to transmit over the reverse link at the lower of two data rates extracted from a plurality of congestion control channels.

It is understood that the present invention can take many forms and embodiments. Accordingly, several variations can be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention can be employed without a corresponding use of the other features. Many such variations and modifications can be considered obvious and desirable by those skilled in the art based upon a review of the foregoing description of preferred embodiments. Accordingly, it is appropriate that the appended claims be construed broadly and in a manner consistent with the scope of the invention.

1. An adaptive method for selecting the scheduling scheme to be used with respect to a given mobile station, the method comprising the steps of:
determining if the given mobile station is not in soft-handoff,
utilizing explicit scheduling of the reverse link communications from the given mobile station if the mobile station is not in soft-handoff;
determining if the given mobile station is in soft-handoff; and
utilizing congestion control scheduling of reverse link communications from the given mobile station if the mobile station is not in soft-handoff.

2. An adaptive method for selecting the scheduling scheme to be used with respect to a given mobile station, the method comprising the steps of:
determining if the given mobile station is not in soft handoff;
utilizing explicit scheduling of reverse link communications from the given mobile station if the mobile station is not in soft-handoff;
determining if the given mobile station is in soft-handoff;
utilizing congestion control scheduling of reverse link communications from the given mobile station if the mobile station is in soft-handoff; and
if the mobile station is in soft hand-off, transmitting by the MS over the reverse link channel at the lowest of the reverse link data rates extracted from the plurality of congestion control commands received by the mobile station.

3. A base station controller (BSC), comprising:
an active set generator; and
a reduced active set generator, wherein the reduced set generator employs output of the active set generator.

4. The BSC of claim 3, wherein the reduced set generator employs reverse link and forward link channel signal strength to determine members of the reduced active set.

5. The BSC of claim 3, wherein the BSC is configured to send indicia of the reduced active set to a BTS.

6. The BSC of claim 3, wherein the active set generator employs measurements of at least one pilot channel energy strength.

7. The BSC of claim 3, wherein the BSC commands an RDCCCH channel to be used if the number of entries in the reduced active set is greater than one.

8. The BSC of claim 3, wherein the BSC commands an RSCACH channel to be used if the number of entries in the reduced active set is equal to one.

9. An MS, comprising:
means for extracting information employable to determine a set of members of an active set;
means for extracting information employable to determine a set of members of a reduced active set; and
means for selecting a congestion control scheduling mode if the number of members of the reduced active set are two or more.

10. The MS of claim 9, further comprising means for selecting an explicit scheduling mode if the number of members of the reduced active set is equal to one.

11. The MS of claim 9, further comprising means for selecting a congestion control mode if the number of members in the reduced active set is equal to one.

12. The MS of claim 9, further comprising means for receiving a plurality of explicit data rate mode channels.

13. The MS of claim 12, further comprising means for selecting one of a plurality of explicit data rate mode channels.

14. The MS of claim 10, wherein the MS is configured to extract a reverse link channel data rate from the explicit control data rate channel.

15. The MS of claim 11, wherein the MS is configured to extract reverse link channel data rate from the congestion control data rate channel.

16. The MS of claim 15, configured to transmit over a reverse link at the lower of the two data rates extracted from a plurality of congestion control channels.

17. A method for dynamically switching between explicit reverse link channel data rate control and reverse link channel data rate congestion control, comprising:
generating a reduced active set;
transmitting indicia of the reduced active set to an MS; and
if the number of members of the reduced active set is greater than one, transmitting reverse link channel data rate control information in congestion control mode.

18. The method of claim 17, wherein the step of generating a reduced active set employs the members of an active set.

19. The method of claim 17, further comprising extracting data rate information in congestion control mode by a mobile station.

20. The method of claim 17, wherein if the numbers of the members of the reduced active set is equal to one, transmitting reverse link channel data rate control information in a explicit control mode.

21. The method of claim 20, further comprising extracting data rate information in explicit mode by a mobile station.

22. A system for setting a reverse link channel data rate through use of an active set and a reduced active set, comprising:
at least one base transceiver station (BTS); and
a base station controller (BSC) coupled to each of the at least one BTSs, the BSC configured to generate the reduced active set.

23. The system of claim 22, wherein the BTS is coupled to a BTS distribution logic.

24. A computer program product for dynamically switching between explicit reverse link channel data rate control and reverse link channel data rate congestion control, the computer program product having a medium with a computer program embodied thereon, the computer program comprising:
computer code for generating a reduced active set;
computer code for transmitting indicia of the reduced active set to an MS; and
if the number of members of the reduced active set is greater than one, computer code for transmitting reverse link channel data rate control information in congestion control mode.

25. A processor for dynamically switching between explicit reverse link channel data rate control and reverse link channel data rate congestion control, the processor including a computer program comprising:
computer code for generating a reduced active set;
computer code for transmitting indicia of the reduced active set to an MS; and
if the number of members of the reduced active set is greater than one, computer code for transmitting reverse link channel data rate control information in congestion control mode.

26. A system for dynamically switching between explicit reverse link channel data rate control and reverse link channel data rate congestion control, comprising:
means for generating a reduced active set;
means for transmitting indicia of the reduced active set to an MS; and
if the number of members of the reduced active set is greater than one, means for transmitting reverse link channel data rate control information in congestion control mode.
